(19) United States
(12) Patent Application Publication
(10) Pub. No.: US 2025/0363124 A1
(43) Pub. Date: Nov. 27, 2025

(54) GRAPH MINING METHOD AND ELECTRONIC DEVICE

(71) Applicant: Alipay (Hangzhou) Information Technology Co., Ltd., Hangzhou (CN)

(72) Inventor: Fanshu LIAO, Hangzhou (CN)

(21) Appl. No.: 19/211,659

(22) Filed: May 19, 2025

(30) Foreign Application Priority Data
May 22, 2024 (CN) 202410646677.6

(51) Int. Cl. G06F 16/2458; G06F 16/901

(52) U.S. Cl. CPC G06F 16/2465; G06F 16/9024

(57) ABSTRACT

A graph mining method includes: obtaining a depth first search (DFS) code corresponding to a to-be-mined full graph in a predetermined scenario; extending a K-th-order pattern and a K-th-order pattern instance of the to-be-mined full graph based on the DFS code, to obtain a (K+1)-th-order pattern and a (K+1)-th-order pattern instance of the to-be-mined full graph, wherein K is an integer greater than or equal to 0; determining, based on quantities of pattern instances corresponding to all orders of patterns of the to-be-mined full graph, support corresponding to all the orders of patterns; and determining a frequent subgraph of the to-be-mined full graph based on the support corresponding to all the orders of patterns.

### CROSS-REFERENCE TO RELATED APPLICATIONS

This application claims priority to Chinese Patent Application No. 202410646677.6, filed on May 22, 2024, the entire content of which is incorporated herein by reference.

### TECHNICAL FIELD

This specification relates to the field of data mining technologies, and in particular, to a graph mining method and an electronic device.

### BACKGROUND

With the frequent occurrence of financial fraud cases, risk control pressure on network platforms is growing day by day. Fraud identification and prevention and control have become the focus of attention in the risk control field, and are crucial to financial security of users and enterprises.

In a related technical solution, years of risk control experience of risk control experts are organized into risk control rules and embedded into risk control systems. The risk control rules based on the risk control experience of the experts can well prevent and control known attacks. However, in this technical solution, a great deal of manual experience is needed, and the accumulated risk control rules need to be continuously and manually updated. Therefore, it may be difficult to cope with a rapidly changing fraud situation in a timely manner.

### SUMMARY

According to a first aspect of this specification, a graph mining method includes: obtaining a depth first search (DFS) code corresponding to a to-be-mined full graph in a predetermined scenario; extending a K-th-order pattern and a K-th-order pattern instance of the to-be-mined full graph based on the DFS code, to obtain a (K+1)-th-order pattern and a (K+1)-th-order pattern instance of the to-be-mined full graph, wherein K is an integer greater than or equal to 0; determining, based on quantities of pattern instances corresponding to all orders of patterns of the to-be-mined full graph, support corresponding to all the orders of patterns; and determining a frequent subgraph of the to-be-mined full graph based on the support corresponding to all the orders of patterns.

According to a second aspect of this specification, an electronic device includes: a processor; and a memory storing instructions executable by the processor. The processor is configured to: obtain a depth first search (DFS) code corresponding to a to-be-mined full graph in a predetermined scenario; extending a K-th-order pattern and a K-th-order pattern instance of the to-be-mined full graph based on the DFS code, to obtain a (K+1)-th-order pattern and a (K+1)-th-order pattern instance of the to-be-mined full graph, wherein K is an integer greater than or equal to 0; determine, based on quantities of pattern instances corresponding to all orders of patterns of the to-be-mined full graph, support corresponding to all the orders of patterns; and determine a frequent subgraph of the to-be-mined full graph based on the support corresponding to all the orders of patterns.

According to a third aspect of this specification, a non-transitory computer-readable storage medium stores instructions that, when executed by a processor, cause the processor to perform a graph mining method. The graph mining method includes: obtaining a depth first search (DFS) code corresponding to a to-be-mined full graph in a predetermined scenario; extending a K-th-order pattern and a K-th-order pattern instance of the to-be-mined full graph based on the DFS code, to obtain a (K+1)-th-order pattern and a (K+1)-th-order pattern instance of the to-be-mined full graph, wherein K is an integer greater than or equal to 0; determining, based on quantities of pattern instances corresponding to all orders of patterns of the to-be-mined full graph, support corresponding to all the orders of patterns; and determining a frequent subgraph of the to-be-mined full graph based on the support corresponding to all the orders of patterns.

### BRIEF DESCRIPTION OF DRAWINGS

The following briefly describes the accompanying drawings of this specification. Clearly, the accompanying drawings in the following descriptions show merely example embodiments of this specification.

FIG. 1 is a schematic diagram of an implementation environment of a graph mining method according to some embodiments.

FIG. 2 is a schematic diagram of an electronic device according to some embodiments.

FIG. 3 is a flowchart of a graph mining method according to some embodiments.

FIG. 4 is a schematic diagram of extending a pattern according to some embodiments.

FIG. 5 is a schematic diagram of two isomorphic subgraphs according to some embodiments.

FIG. 6 is a schematic diagram of extending a pattern according to some embodiments.

FIG. 7 is a flowchart of extending a pattern instance according to some embodiments.

FIG. 8 is a schematic diagram of extending a pattern instance in a multithreaded manner according to some embodiments.

FIG. 9 is a flowchart of a graph mining method applied to a distributed system according to some embodiments.

FIG. 10 is a schematic diagram of a graph mining method according to some embodiments.

FIG. 11 is a domain model diagram of various modules for implementing a graph mining method according to some embodiments.

FIG. 12 is a schematic diagram of a graph mining method according to some embodiments.

It should be understood that the accompanying drawings are merely used for the purpose of illustration and description, and are not intended to limit the scope of this specification. It should be further understood that the accompanying drawings may not be drawn to scale.

### DETAILED DESCRIPTION OF EMBODIMENTS

Example embodiments of this specification are provided in the following descriptions, and various modifications to the example embodiments may be made by a person skilled in the art. In addition, the general principles defined herein can be applied to other embodiments and applications without departing from the spirit and scope of this specification. Therefore, the claims of this specification are not limited to the example embodiments.

The terms used herein are merely intended to describe specific example embodiments, and not to impose limitation. For example, unless otherwise explicitly stated in the context, the singular forms “one”, “an”, and “the” used herein can include plural forms. When being used in this specification, the terms “include”, “comprise”, and/or “have” mean existence of an associated integer, step, operation, element, and/or component, but do not preclude existence of one or more other features, integers, steps, operations, elements, components, and/or groups or addition of other features, integers, steps, operations, elements, components, and/or groups to the system/method.

The flowchart used in this specification shows operations implemented by a system according to some embodiments of this specification. It should be clearly understood that the operations in the flowchart may not be implemented in the shown order. On the contrary, the operations can be implemented in a reverse order or simultaneously. In addition, one or more other operations can be added to the flowchart, and one or more operations can be removed from the flowchart.

First, terms used in one or more embodiments of this specification are explained.

Graph mining refers to a process of mining a corresponding subgraph from large-scale graph data based on graph knowledge and a mining objective, and extracting useful information.

Depth first search (DFS) code: A complete graph can be described through DFS traversal. Each edge of the graph can be described by using a quintuple <i, j, label_i, label_e, label_j>, where i is a start node identifier of the edge, j is an end node identifier of the edge, label_i is a start node label of the edge, label_e is an edge label, and label_j is an end node label of the edge. A pattern can be represented by using a list of such quintuples. This list is referred to as a DFS code.

A pattern represents a specific subgraph structure, and is a logical concept. The pattern can include information such as a graph topology structure, a node/edge attribute, and a label. For example, the subgraph structure corresponding to the pattern can be a closed structure such as a ring structure or a non-closed structure such as a chain structure. For example, a structure from a node A to B and then to C in a graph can be a closed ring pattern or a non-closed chain pattern.

A pattern instance (also referred to as Embedding) is a specific node and edge corresponding to a pattern in a graph.

Instance code: A pattern instance is represented by using a specific value of the DFS code, to obtain an instance code corresponding to the pattern instance. For example, the instance code corresponding to the pattern instance is (0, 1, A, e, A).

Pattern code: A code of a pattern of a subgraph structure is formed based on the DFS code of the graph. For example, for a 1st-order pattern A->A, a corresponding pattern code can be (i, j, A, e, A, out) or (A_i, e, A_j, out), and a corresponding instance code can include (0, 1, A, e, A), (1, 2, A, e, A), etc.

A canonical pattern code is a pattern code used to uniquely identify the pattern. For a subgraph corresponding to a pattern, different DFS codes can be obtained based on different traversal manners. However, after the different DFS codes are arranged in a lexicographic order, there is a unique minimum DFS code, and a pattern code corresponding to the minimum DFS code is a canonical pattern code of the pattern. A necessary and sufficient condition for two subgraphs to be isomorphic is that canonical pattern codes, namely, min DFS codes, of the two subgraphs are the same.

Support represents occurrence frequency of a pattern in a graph, for example, a quantity of occurrences. An MNI indicator is a classical support calculation method.

Graph mining can be a process of discovering and extracting useful knowledge and information from massive data by using a graph model. Knowledge and information obtained through graph mining are widely applied to various fields, for example, the risk control field and the social network analysis field. In a related technical solution, in the credit risk control field, risk identification is implemented by depicting an association between entities by using a graph model. For example, fraud rings are identified by using graph technologies such as risk label propagation and community detection algorithms. However, such technical solutions often lag in time, making it difficult to effectively intercept and defend against new and unknown fraud patterns.

Based on the above content, embodiments of this specification provide a graph mining method and an electronic device. On one hand, a K-th-order pattern and a K-th-order pattern instance of a to-be-mined full graph are extended based on a DFS code, to obtain a (K+1)-th-order pattern and a (K+1)-th-order pattern instance of the to-be-mined full graph. In this way, the pattern and the instance of the graph can be automatically and efficiently extended, thereby improving graph mining efficiency. On the other hand, support corresponding to all orders of patterns of the to-be-mined full graph is determined based on quantities of pattern instances corresponding to all the orders of patterns; and a subgraph corresponding to a target-order pattern whose support is greater than a predetermined support threshold is determined as a frequent subgraph of the to-be-mined full graph. In this way, various potential risk patterns can be automatically and efficiently mined on a relation graph in an unsupervised graph mining manner, so that a corresponding risk pattern can be sensed in an earlier phase of a lifecycle of a large-scale fraud behavior, to cope with a rapidly changing fraud situation in a timely manner and automatically perform fraud risk control.

The following describes in detail example embodiments of this specification with reference to the accompanying drawings.

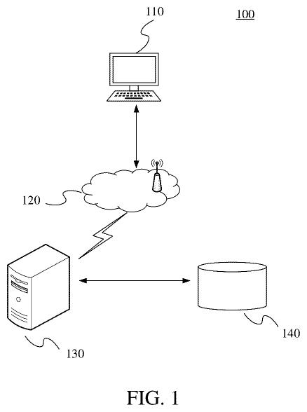

FIG. 1 is a schematic diagram of an implementation environment 100 of a graph mining method according to some embodiments.

As shown in FIG. 1, the implementation environment 100 can include a terminal 110, a server 130, and a database 140.

The terminal 110 is connected to the server 130 through a wireless network or a wired network 120. The terminal 110 can be a tablet computer, a notebook computer, a desktop computer, etc., but is not limited thereto.

The terminal 110 can store data or instructions for performing the graph mining method described in this specification. The terminal 110 can include a hardware device with a data information processing capability and a necessary program needed for driving the hardware device to work.

The server 130 is an independent physical server; a server cluster or a distributed system including a plurality of physical servers; a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform; etc. The server 130 provides a background service to an application running on the terminal 110.

The server 130 is provided with an integrated development platform. The integrated development platform is also referred to as an integrated development environment (IDE). The integrated development platform is an application used to provide a program development environment, and usually includes tools such as a code editor, a compiler, a debugger, and a graphical user interface. A developer can write program code on the integrated development platform (that is, perform program development). An integrated development platform server can be a computing device specifically used by the integrated development platform to implement the graph mining method. The server 130 can separately perform data communication with the terminal 110 and the database 140.

In addition, the server 130 can store data or instructions for performing the graph mining method described in this specification. The server 130 can include a hardware device with a data information processing capability and a necessary program needed for driving the hardware device to work. The server 130 can also be only a hardware device with a data processing capability, or can be only a program that runs in the hardware device. In some embodiments, the server 130 can serve as a plug-in and be deployed on the terminal 110. In this case, the server 130 stores data or instructions for performing the graph mining method corresponding to the terminal 110 described in this specification.

The database 140 can store data and/or instructions. In some embodiments, the database 140 can store a DFS code corresponding to a to-be-mined full graph, an instance cache, etc. In some embodiments, the database 140 can store data and/or instructions used by the server 130 to perform the graph mining method described in this specification. The terminal 110 and the server 130 have permission to access the database 140, and the terminal 110 and the server 130 can access, through a network, the data or instructions stored in the database 140. In some embodiments, the database 140 can be directly connected to the terminal 110 and the server 130. In some embodiments, the database 140 can be a part of the server 130. In some embodiments, the database 140 can include a mass memory, a removable memory, a volatile read-write memory, a read-only memory (ROM) or similar content, or any combination thereof. Example mass memories may include a non-transitory storage medium such as a disk, an optical disc, or a solid-state drive. Example removable memories may include a flash drive, a floppy disk, an optical disc, a storage card, a zip disk, a magnetic tape, etc. A typical volatile read-write memory may include a random access memory (RAM). Example RAMs may include a dynamic RAM (DRAM), a double data rate synchronous dynamic RAM (DDR SDRAM), a static RAM (SRAM), a thyristor RAM (T-RAM), a zero-capacitor RAM (Z-RAM), etc. Example ROMs can include a mask ROM (MROM), a programmable ROM (PROM), an erasable programmable ROM (EPROM), an electrically erasable programmable ROM (EEPROM), a compact disc (CD-ROM), a digital versatile disc ROM, etc.

A person skilled in the art can learn that there can be more or fewer terminals. For example, there is only one terminal, or there are dozens or hundreds of terminals, or there are more terminals. In this case, the implementation environment further includes another terminal. A quantity of terminals and a device type are not limited in embodiments of this specification.

After the implementation environment in embodiments of this specification is described, the following describes an application scenario of embodiments of this specification with reference to the implementation environment. In the following description process, the terminal is the terminal 110 in the implementation environment, and the server is the server 130 in the implementation environment. The technical solutions provided in the embodiments of this specification can be applied to a risk control scenario, social network analysis, and the network security field, for example, a risk control scenario of a financial platform.

An example in which the technical solutions provided in the embodiments of this specification are applied to the risk control scenario of the financial platform is used. In this case, the to-be-mined full graph can be an inter-account transfer relation graph, and the server 130 obtains a DFS code corresponding to the to-be-mined full graph in the risk control scenario; extends a K-th-order pattern and a K-th-order pattern instance of the to-be-mined full graph based on the DFS code, to obtain a (K+1)-th-order pattern and a (K+1)-th-order pattern instance of the to-be-mined full graph, where K is a positive integer; determines, based on quantities of pattern instances corresponding to all orders of patterns of the to-be-mined full graph, support corresponding to all the orders of patterns; and determines a subgraph corresponding to a target-order pattern whose support is greater than a predetermined support threshold as a frequent subgraph of the to-be-mined full graph.

It should be noted that descriptions are provided above by using an example in which the technical solutions provided in the embodiments of this specification are applied to the risk control scenario. The technical solutions provided in the embodiments of this specification can also be applied to another appropriate scenario, for example, a customer relation network analysis scenario or an intelligent decision scenario.

It should be noted that the steps in the graph mining method in the example embodiments of this specification can be partially performed by a client and partially performed by a server, or can be entirely performed by a server or entirely performed by a client. This is not specifically limited in this specification.

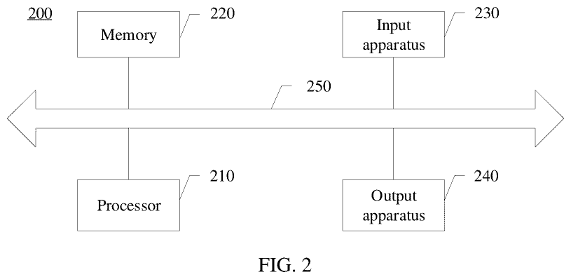

Based on the implementation environment shown in FIG. 1, the following describes, with reference to FIG. 2 to FIG. 11, in detail the graph mining method and the electronic device provided in the embodiments of this specification. It should be noted that the implementation environment is merely shown for ease of understanding of the spirit and principle of this specification, and the embodiments of this specification are not limited in this aspect. On the contrary, the embodiments of this specification can be applied to any applicable scenario.

FIG. 2 is a schematic diagram of an electronic device 200 according to some embodiments. The electronic device 200 can perform the graph mining method described in this specification. The electronic device 200 can be a general-purpose computer or a dedicated computer. For example, the electronic device 200 can be a server, a personal computer, or a portable computer (for example, a notebook computer or a tablet computer), or can be another electronic device with a computing capability. For example, the electronic device can be the terminal 210 or the server 130 in FIG. 1, or can be a terminal device that is used by a plurality of developers to perform program development on an integrated development platform.

The electronic device 200 can include one or more of the following components: a processor 210, a memory 220, an input apparatus 230, an output apparatus 240, and a bus 250. The processor 210, the memory 220, the input apparatus 230, and the output apparatus 240 can be connected through the bus 250.

The processor 210 can include one or more processing cores. The processor 210 is connected to all parts of the entire electronic device through various interfaces and lines, and performs the graph mining method described in this specification by running or executing instructions, a program, a code set, or an instruction set stored in the memory 220 and invoking data stored in the memory 220. In some embodiments, the processor 210 can be implemented in at least one hardware form in a digital signal processor (DSP), a field-programmable gate array (FPGA), and a programmable logic array (PLA). One or a combination of a central processing unit (CPU), a graphics processing unit (GPU), a modem, etc. can be integrated into the processor 210. The CPU mainly processes an operating system, a user interface, an application, etc. The GPU is configured to be responsible for rendering and drawing display content. The modem is configured to process wireless communication. It can be understood that the modem can alternatively be implemented by a single communication chip without being integrated into the processor 210.

The memory 220 can include a random access memory (RAM), or can include a read-only memory (ROM). In some embodiments, the memory 220 includes a non-transitory computer-readable storage medium. The memory 220 can be configured to store instructions, a program, code, a code set, or an instruction set. The memory 220 can include a program storage area and a data storage area. The program storage area can store an instruction for implementing an operating system, an instruction for implementing at least one function (for example, a touch function, a sound playing function, or an image playing function), an instruction for implementing the following method embodiments, etc. The operating system can be an Android system, including a system deeply developed based on the Android system; or an IOS system, including a system deeply developed based on the IOS system; or another system.

To enable the operating system to distinguish between specific application scenarios of a third-party application, data communication between the third-party application and the operating system needs to be enabled, so that the operating system can obtain current scenario information of the third-party application at any time, and then perform targeted system resource adaptation based on a current scenario.

The input apparatus 230 is configured to receive input instructions or data, and the input apparatus 230 includes but is not limited to a keyboard, a mouse, a camera, a microphone, or a touch device. The output apparatus 240 is configured to output instructions or data, and the output apparatus 240 includes but is not limited to a display device, a speaker, etc. In an example, the input apparatus 230 and the output apparatus 240 can be disposed together, and the input apparatus 230 and the output apparatus 240 are touchscreens.

In addition, a person skilled in the art can understand that a structure of the electronic device is not limited to that shown in FIG. 2. The electronic device can include more or fewer components than those shown in the figure, or combine some components, or have different component arrangements. For example, the electronic device further includes components such as a radio frequency circuit, an input unit, a sensor, an audio circuit, a wireless fidelity (Wi-Fi) module, a power supply, and a Bluetooth module. Details are not described herein.

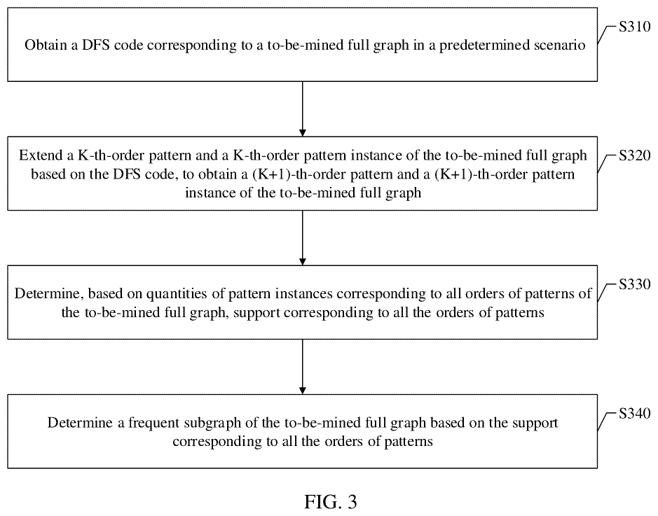

FIG. 3 is a flowchart of a graph mining method according to some embodiments. For example, the electronic device 200 can perform the graph mining method. Specifically, the processor 210 can read an instruction set stored in a local storage medium of the electronic device, and then perform the graph mining method based on the instruction set. In the following, the graph mining method is described in detail with reference to the accompanying drawings.

As shown in FIG. 3, in step S310, a DFS code corresponding to a to-be-mined full graph in a predetermined scenario is obtained.

In an example embodiment, the predetermined scenario can be a risk control scenario, a social network analysis scenario, etc., and the to-be-mined full graph is a relation graph in the predetermined scenario, for example, an entity relation graph. The risk control scenario is used as an example. In this case, the to-be-mined full graph can be an inter-account transfer relation graph in the risk control scenario, a node in the graph represents an account, and an edge in the graph represents a transfer behavior. The electronic device 200 obtains a graph dataset of the to-be-mined full graph in the risk control scenario. The graph dataset includes an identifier of the to-be-mined full graph and corresponding node and edge information. The graph dataset is traversed through depth first search (DFS), an order of nodes/edges in the to-be-mined full graph is recorded, and a DFS code corresponding to the graph dataset is generated. The DFS code corresponding to the to-be-mined full graph can be used to represent a node visit sequence recorded when the graph is traversed through depth first search. That is, the DFS code corresponding to the to-be-mined full graph can represent a DFS spanning tree that starts from a given vertex, and the given vertex can be a root node, or can be a preset seed node.

DFS is a recursive traversal algorithm. When the graph is traversed through DFS, a branch is searched as deeply as possible until a leaf node is reached, and then backtracking to a previous layer of node is performed and another branch continues to be explored. Through DFS, all nodes in the graph can be effectively traversed, and a status of a visited node is recorded, to discover a deep connection relation and a loop structure. The to-be-mined full graph is traversed through DFS, and each edge in the traversed graph can be described by using the DFS code. In an example embodiment, the DFS code can be a code in a form of a sextuple, and the sextuple includes a start node identifier of an edge, an end node identifier of the edge, a start node label of the edge, an edge label, an end node label of the edge, and a direction of the edge. For example, the DFS code can be represented by using the following sextuple form: <i, j, label_i, label_e, label_j, direction>, where i and j represent a start node identifier and an end node identifier of an edge during traversal, that is, an index order, label_i, label_e, and label_j respectively represent a start node label, an edge label, and an end node label of the edge, and direction represents a direction (out or in) of the edge.

According to the technical solution in the above example embodiment, the DFS code can be represented by using the sextuple form, and the direction of the edge is introduced based on a quintuple form to extend the DFS code. Because an order and a direction of nodes/edges during traversal can be more accurately represented, a pattern and an instance of the graph can be more efficiently extended to improve graph mining efficiency, and more potential risk patterns can be obtained through extension.

The risk control scenario is used as an example. It is assumed that the to-be-mined full graph is an inter-account transfer relation graph in the risk control scenario, a node in the graph represents an account, and an edge represents a transfer behavior. The electronic device 200 traverses the inter-account transfer relation graph through DFS to determine a DFS code corresponding to the inter-account transfer relation graph. The DFS code can be used to search for a potential risk pattern, for example, a risk association or a risk structure between a plurality of accounts.

In step S320, a K-th-order pattern and a K-th-order pattern instance of the to-be-mined full graph are extended based on the DFS code, to obtain a (K+1)-th-order pattern and a (K+1)-th-order pattern instance of the to-be-mined full graph.

In an example embodiment, a pattern represents a specific subgraph structure, and the pattern includes information such as a graph topology structure, a node/edge attribute, and a label, and is a logical concept. The subgraph structure of the pattern can be a closed structure such as a ring structure or a non-closed structure such as a chain structure. Each of the subgraph structures belongs to one pattern. The K-th-order pattern indicates that the pattern has K edges. Herein, K is an integer greater than or equal to 0. For example, when K is 0, it indicates that the pattern is a node, that is, has 0 edges; when K is 1, it indicates that the pattern has one edge; and when K is 2, it indicates that the pattern has two edges. The K-th-order pattern instance is a specific node and edge corresponding to the K-th-order pattern in the to-be-mined full graph.

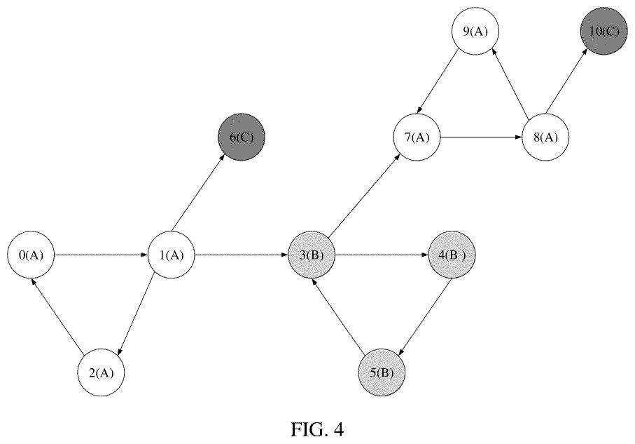

Further, a pattern code is at least one code generated based on a DFS code corresponding to a subgraph of the pattern in the to-be-mined full graph. A pattern code of a pattern can be represented by using <label_i, label_e, label_j, direction> or <i, j, label_i, label_e, label_j, direction> in the sextuple, and an instance code of a pattern instance of a pattern can be represented by using a specific value of the sextuple <i, j, label_i, label_e, label_j, direction> of the DFS code. For example, with reference to FIG. 4, in each node in FIG. 4, a number is an index of each node, and a letter in parentheses represents a label of the node. A 1st-order pattern includes patterns A->A, A->B, A->C, B->B, B->A, etc., and a 1st-order pattern code corresponding to the 1st-order pattern A->A includes (A_i, e, A_i+1, out). A 2nd-order pattern includes patterns A->A->A, A->A->B, A->A->C, etc., and a 2nd-order pattern code corresponding to the 2nd-order pattern A->A->B includes {(A_i, e, A_i+1, out) and (A_i+1, e, B_i+3, out)}. A 3rd-order pattern includes patterns A->A->A->A, A->A->B->B, A->A->B->A, etc., the 3rd-order pattern A->A->A->A forms a pattern of a ring structure, and a corresponding pattern code includes {(A_i, e, A_i+1, out), (A_i+1, e, A_i+2, out), (A_i+2, e, A_i, out)}.

Further, the K-th-order pattern of the to-be-mined full graph is extended to the (K+1)-th-order pattern, that is, based on the existing K-th-order pattern, a node and a corresponding connection relation of the node are added while an original connection relation is maintained, to form a larger subgraph pattern. In an example embodiment, the electronic device 200 determines a pattern code corresponding to the K-th-order pattern of the to-be-mined full graph, and extends the K-th-order pattern and the K-th-order pattern instance of the to-be-mined full graph based on the pattern code corresponding to the K-th-order pattern, to obtain the (K+1)-th-order pattern and the (K+1)-th-order pattern instance of the to-be-mined full graph.

For example, with reference to FIG. 4, if the example graph in FIG. 4 is the to-be-mined full graph, and the current K-th-order pattern of the to-be-mined full graph is a 1st-order pattern A->A, a pattern code corresponding to the 1st-order pattern includes (A_i, e, A_i+1, out), and an instance code of a pattern instance corresponding to the 1st-order pattern includes (0, 1, A, e, A, out) briefly referred to as an instance (0, 1), an instance (1, 2, A, e, A, out) briefly referred to as an instance (1, 2), an instance (7, 8), and an instance (8, 9). The 1st-order pattern is extended, that is, an edge is added, to obtain the following (K+1)-th-order patterns, namely, 2nd-order patterns, of the to-be-mined full graph: (1) 2nd-order pattern 1, namely, A->A->A: A pattern code of the 2nd-order pattern includes {(A_i, e, A_i+1, out), (A_i+1, e, A_i+2, out)}, and an instance code of a corresponding pattern instance includes {(0, 1, A, e, A, out), (1, 2, A, e, A, out)} briefly referred to as an instance (0, 1, 2), and an instance (7, 8, 9). (2) 2nd-order pattern 2, namely, A->A->B: A pattern code of the 2nd-order pattern includes {(A_i, e, A_i+1, out), (A_i+1, e, B_i+3, out)}, and a corresponding pattern instance includes an instance (0, 1, 3). (3) 2nd-order pattern 3, namely, A->A->C: A pattern code of the 2nd-order order pattern includes {(A_i, e, A_i+1, out), (A_i+1, e, C_i+6, out)} and {(A_i, e, A_i+1, out), (A_i+1, e, C_i+3, out)}, and a corresponding pattern instance includes an instance (0, 1, 6) and an instance (7, 8, 10). The 2nd-order patterns are extended to obtain the following 3rd-order patterns of the to-be-mined full graph: (1) A->A->A->A: A pattern code of the 3rd-order pattern includes {(A_i, e, A_i+1,out), (A_i+1, e, A_i+2, out), (A_i+2, e, A_i, out)}, and a corresponding pattern instance includes an instance (0, 1, 2, 0) and an instance (7, 8, 9, 7). (2) A->A->B->B: A pattern code of the 3rd-order pattern includes {A_i, e, A_i+1, out), (A_i+1, e, B_i+3, out), (B_i+3, e, B_i+4, out), and a corresponding pattern instance includes an instance (0, 1, 3, 4).

Further, one (K+1)-th-order pattern corresponds to at least one (K+1)-th-order pattern code. In an example embodiment, if a target (K+1)-th-order pattern code corresponding to the (K+1)-th-order pattern is a canonical pattern code, where the canonical pattern code is a pattern code used to uniquely identify the pattern, the electronic device 200 determines the (K+1)-th-order pattern instance from the to-be-mined full graph based on the target (K+1)-th-order pattern code and the K-th-order pattern instance; or if a target (K+1)-th-order pattern code is not a canonical pattern code, the electronic device 200 discards the target (K+1)-th-order pattern code, to avoid repeated calculation. The canonical pattern code represents a code sequence with a smallest code sequence order in the DFS code of the pattern graph. One pattern may have a plurality of pattern codes, and a pattern code with a smallest DFS code sequence order is selected as a unique code, namely, a canonical pattern code, of the pattern. Isomorphic subgraphs have a same canonical pattern code.

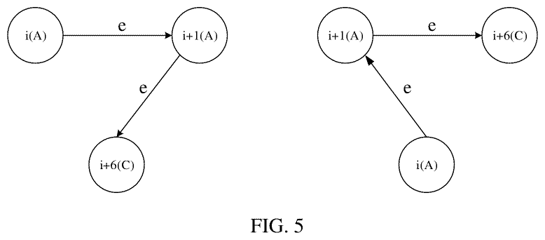

For example, with reference to FIG. 5, the graph represents a 2nd-order pattern A->A->C obtained through extension, and a pattern code corresponding to the 2nd-order pattern A->A->C includes {(A_i, e, A_i+1, out), (A_i+1, e, C_i+6, out)}, {(A_i+1, e, C_i+6, out), (A_i+1, e, A_i, in)}. Subgraph structures of two subgraphs of the 2nd-order pattern are the same. However, there are two different pattern codes. A pattern code of a subgraph on a left side is {(i, i+1, A, e, A, OUT), (i+1, i+6,A, e, C, OUT)}, and a pattern code of a subgraph on a right side is {(i+1, i+6, A, e, C, OUT), (i+1, i, A, e, A, IN). Code sequence orders of a DFS code corresponding to the pattern code of the subgraph on the left side and a DFS code corresponding to the pattern code of the subgraph on the right side are compared. For example, a DFS code element (i, i+1) of the subgraph on the left side and a DFS code element (i+1, i+6) of the subgraph on the right side are compared. It is found, after comparison, that the code sequence order of the subgraph on the left side is less than the code sequence order of the subgraph on the right side. Therefore, the pattern code {(i, i+1, A, e, A, OUT), (i+1, i+6, A, e, C, OUT)}, namely, a pattern code {(A_i, e, A_i+1, out), (A_i+1, e, C_i+6, out)}, is used as a canonical pattern code of the subgraph structure in FIG. 5.

According to the technical solution in the above example embodiment, when a pattern code corresponding to a target (K+1)-th-order pattern is the canonical pattern code, the (K+1)-th-order pattern instance is determined from the to-be-mined full graph. In this way, graph isomorphism testing and duplicate graph detection can be combined through the canonical pattern code, to avoid searching an obtained frequent subgraph set for a duplicate subgraph, that is, avoid a problem of generating a redundant candidate subgraph.

In some example embodiments, the graph mining method is applied to a distributed system, the distributed system includes a plurality of partitions, and electronic devices 200 in all the partitions extend the K-th-order pattern and the K-th-order pattern instance of the to-be-mined full graph based on the DFS code, to obtain (K+1)-th-order patterns and (K+1)-th-order pattern instances of the to-be-mined full graph that correspond to all the partitions. For example, it is assumed that one partition in the distributed system corresponds to one electronic device 200. The electronic device 200 extends the K-th-order pattern and the K-th-order pattern instance of the to-be-mined full graph in a current partition based on the pattern code corresponding to the K-th-order pattern, to obtain the (K+1)-th-order pattern and the (K+1)-th-order pattern instance in the current partition.

In step S330, support corresponding to all orders of patterns of the to-be-mined full graph is determined based on quantities of pattern instances corresponding to all the orders of patterns.

In an example embodiment, the support represents occurrence frequency of a pattern in the graph. An objective of frequent subgraph mining is to find a pattern graph whose support, namely, frequency, is greater than a given threshold from a graph set, that is, a pattern that occurs frequently. The support needs to meet anti-monotonicity. The anti-monotonicity indicates that if a graph is frequent, a subgraph of the graph is definitely frequent; or if a subgraph is infrequent, a supergraph is definitely infrequent. A support indicator for the predetermined scenario needs to meet anti-monotonicity. Otherwise, effective pruning cannot be performed based on the support. A minimum image based (MNI) indicator can be used as an indicator for support calculation. The MNI indicator is a commonly used support calculation indicator in frequent subgraph mining, and is mainly used to calculate a set of corresponding nodes based on all instances of a pattern, to meet anti-monotonicity.

It should be noted that although descriptions are provided by using an example in which the support indicator is the MNI indicator, a person skilled in the art should understand that the support indicator can be another appropriate indicator such as a maximum independent set (MIS) indicator, a risk degree, etc. that meets anti-monotonicity. This also falls within the scope of the embodiments of this specification.

Further, the electronic device 200 determines, based on the quantities of pattern instances corresponding to all the orders of patterns of the to-be-mined full graph, the support corresponding to all the orders of patterns. For example, the electronic device 200 performs summation on the quantities of pattern instances corresponding to all the orders of patterns of the to-be-mined full graph, to obtain a total instance quantity of pattern instances of all the orders of patterns, and uses the quantities of pattern instances corresponding to all the orders of patterns as the support corresponding to all the orders of patterns. With reference to FIG. 4, pattern instances and instance quantities of all orders of patterns obtained by extending the 1st-order pattern A->A in FIG. 4 are shown in Table 1:

TABLE 1
Pattern instances and quantities corresponding to all the orders
of patterns obtained by extending the 1st-order pattern A->A

| | | Instance |
|---|---|---|
| Pattern | Pattern instance | quantity |
| 1st-order pattern A->A | (0, 1), (1, 2), (2, 0), (7, 8), (8, 9), and (9, 7) | 6 |
| 2nd-order pattern A->A->A | (0, 1, 2), (1, 2, 0), (7, 8, 9), and (8, 9, 7) | 4 |
| 2nd-order pattern A->A->B | (0, 1, 3) | 1 |
| 2nd-order pattern A->A->C | (0, 1, 6) and (7, 8, 10) | 2 |
| 3rd-order pattern A->A->A->A | (0, 1, 2, 0) and (7, 8, 9, 7) | 2 |
| 3rd-order pattern A->A->B->B | (0, 1, 3, 4) | 1 |
| . . . | . . . | . . . |

With reference to Table 1, if the quantities of pattern instances corresponding to all the orders of patterns are determined as support corresponding to all the orders of patterns, support of the 1st-order pattern A->A is 6, support corresponding to the 2nd-order pattern A->A->A is 4, support corresponding to the 2nd-order pattern A->A->B is 1, support corresponding to the 2nd-order pattern A->A->C is 2, support corresponding to the 3rd-order pattern A->A->A->A is 2, and support corresponding to the 3rd-order pattern A->A->B->B is 1.

In some example embodiments, the graph mining method is applied to the distributed system, the distributed system includes a plurality of partitions, and the electronic devices 200 in all the partitions collect statistics on the (K+1)-th-order pattern instances in all the partitions, to obtain sub-support information in all the partitions. The sub-support information includes pattern instance quantities or instance identifiers of pattern instances in all the partitions. The electronic device 200 sends the sub-support information in the current partition to a target partition in the distributed system based on a pattern extension manner of the (K+1)-th-order pattern in the current partition. An electronic device 200 in the target partition aggregates the sub-support information of the (K+1)-th-order pattern in all the partitions, to obtain a support indicator of the (K+1)-th-order pattern. The support indicator meets anti-monotonicity, and the support indicator can be an MNI indicator.

For example, for the distributed system, each partition may have a corresponding pattern instance for a same pattern, and global support cannot be directly calculated. Therefore, in an aggregation phase, in some example embodiments, the electronic devices 200 in all the partitions send sub-support information of the same pattern to a same partition, namely, the target partition. For example, the sub-support information of the (K+1)-th-order pattern in all the partitions is sent to the target partition. The electronic device 200 in the target partition summarizes and aggregates the received sub-support information of the (K+1)-th-order pattern, to calculate the support indicator, for example, an MNI value, corresponding to the pattern.

In step S340, a frequent subgraph of the to-be-mined full graph is determined based on the support corresponding to all the orders of patterns.

In some example embodiments, a predetermined support threshold is a support threshold set based on the predetermined scenario. If the support is greater than the predetermined support threshold, it indicates that the pattern occurs frequently in the to-be-mined full graph. The risk control scenario is used as an example. The support indicator can be an MNI indicator, and the predetermined support threshold can be set based on a risk control requirement of the risk control scenario. The electronic device 200 compares support of each (K+1)-th-order pattern with the predetermined support threshold. If the support indicator of the (K+1)-th-order pattern is greater than the predetermined support threshold, the (K+1)-th-order pattern is determined as a target-order pattern that meets the support indicator; and a subgraph corresponding to the target-order pattern is determined as the frequent subgraph of the to-be-mined full graph.

For example, the risk control scenario is used as an example. It is assumed that the to-be-mined full graph is an inter-account transfer relation graph in the risk control scenario, a node in the graph represents an account, and an edge represents a transfer behavior. With reference to FIG. 4 and Table 1, it is assumed that the support threshold is 2, and support corresponding to a 3rd-order pattern A->A->A->A of the to-be-mined full graph is 2. The electronic device 200 compares the support of the 3rd-order pattern with the predetermined support threshold, and the support of the 3rd-order pattern is equal to the predetermined support threshold 2. In this case, the 3rd-order pattern is determined as the target-order pattern that meets the support indicator; and a subgraph corresponding to the 3rd-order pattern is determined as the frequent subgraph of the to-be-mined full graph, that is, pattern instances (0, 1, 2, 0) and (7, 8, 9, 7) in FIG. 4.

It should be noted that although descriptions are provided by using the risk control scenario as an example, a person skilled in the art should understand that corresponding support and a corresponding support threshold can be set with reference to a specific scenario. For example, the support is a risk degree of a pattern, and the corresponding support threshold is a risk threshold. This also falls within the scope of the embodiments of this specification. Corresponding support and support thresholds are set for different scenarios, so that more expected patterns can be more effectively mined for a specific scenario.

In some other example embodiments, the electronic device 200 ranks all the orders of patterns in descending order of the support corresponding to all the orders of patterns, and selects a predetermined quantity of top-ranked target-order patterns; and determines a subgraph corresponding to the target-order pattern as the frequent subgraph of the to-be-mined full graph.

According to the technical solution in the example embodiment in FIG. 3, on one hand, a K-th-order pattern and a K-th-order pattern instance of a to-be-mined full graph are extended based on a DFS code, to obtain a (K+1)-th-order pattern and a (K+1)-th-order pattern instance of the to-be-mined full graph. In this way, the pattern and the instance of the graph can be automatically and efficiently extended, thereby improving graph mining efficiency. On the other hand, support corresponding to all orders of patterns of the to-be-mined full graph is determined based on quantities of pattern instances corresponding to all the orders of patterns; and a subgraph corresponding to a target-order pattern whose support is greater than a predetermined support threshold is determined as a frequent subgraph of the to-be-mined full graph. In this way, various potential risk patterns can be automatically and efficiently mined on a relation graph in an unsupervised graph mining manner, so that a corresponding risk pattern can be sensed in an earlier phase of a lifecycle of a large-scale fraud behavior, to cope with a rapidly changing fraud situation in a timely manner and automatically perform fraud risk control.

The following describes in detail the pattern extension. The pattern extension means that for a K-th-order pattern, an edge is added to obtain a (K+1)-th-order pattern. The electronic device 200 extends the K-th-order pattern through pattern extension based on the K-th-order pattern code corresponding to the K-th-order pattern of the to-be-mined full graph, to obtain a plurality of (K+1)-th-order patterns of the to-be-mined full graph. For example, for each K-th-order pattern, the electronic device 200 determines a K-th-order pattern code corresponding to the K-th-order pattern of the to-be-mined full graph, and extends the K-th-order pattern through forward edge extension based on the K-th-order pattern code corresponding to the K-th-order pattern, to obtain at least one (K+1)-th-order pattern of the to-be-mined full graph; and extends the K-th-order pattern through backward edge extension based on the K-th-order pattern code corresponding to the K-th-order pattern, to obtain at least one (K+1)-th-order pattern of the to-be-mined full graph.

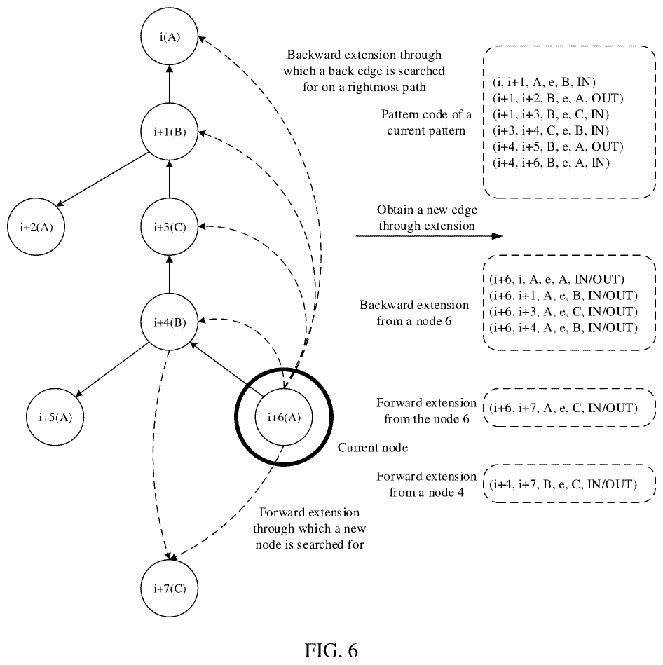

With reference to FIG. 6, a left side of FIG. 6 represents a pattern obtained through extension, where a number is an index of each node, a letter in parentheses represents a label of the node, a current node is a seventh node, namely, a node 6, indicating that the current pattern is a 6th-order pattern, a solid line represents an edge obtained through extension, and a dashed line represents an edge that can be obtained through extension in a next step. A pattern code, that is, {(i, i+1, A, e, B, IN), (i+1, i+2, B, e, A, OUT), (i+1, i+3, B, e, C, IN), (i+3, i+4, C, e, B, IN), (i+4, i+5, B, c, A, OUT), (i+4, i+6, B, e, A, IN)}, of the 6th-order pattern is listed on a right side of the figure.

Still with reference to FIG. 6, there are the following two pattern extension manners of adding an edge: (1) Backward edge extension: Backward edge extension is to search for a back edge from a last node on a rightmost path corresponding to the pattern code to another node on the rightmost path. That is, a target node of a newly added edge is a node in a current K-th-order pattern, namely, the 6th-order pattern. As shown in FIG. 6, starting from a node i+6, other nodes (0, 1, 3, 4) on the rightmost path of the current-order pattern are separately searches for, and four backward edges can be obtained through extension. Pattern codes corresponding to the four backward edges are respectively (i+6, i, A, e, A, IN/OUT), (i+6, i+1, A, e, B, IN/OUT), (i+6, i+3, A, e, C, IN/OUT), and (i+6, i+4, A, e, B, IN/OUT). Therefore, pattern codes corresponding to (K+1)-th-order patterns, namely, 7th-order patterns, are respectively {code of the 6th-order pattern, (i+6, i, A, e, A, IN/OUT)}, {code of the 6th-order pattern, (i+6, i+1, A, e, B, IN/OUT)}, {code of the 6th-order pattern, (i+6, i+3,A, e, C, IN/OUT)}, and {code of the 6th-order pattern, (i+6, i+4, A, e, B, IN/OUT)}. (2) Forward edge extension: Forward edge extension is to search, starting from a node on a rightmost path, for a new node id to perform extension. That is, a target point of a newly added node is not in a current K-th-order pattern. As shown in FIG. 6, a new node i+7 can be obtained through extension starting from a node (i, i+1, i+3, i+4, i+6) on the rightmost path. A new node i+7 is obtained through forward extension from the node 6, and a corresponding pattern code is (i+6, i+7, A, e, C, IN/OUT). Therefore, a pattern code corresponding to a (K+1)-th-order pattern, namely, a 7th-order pattern, is {code of the 6th-order pattern, (i+6, i+7, A, e, C, IN/OUT)}. A new node i+7 is obtained through forward extension from the node i+4, and a corresponding pattern code is (i+4, i+7, B, e, C, IN/OUT). Therefore, a pattern code corresponding to a (K+1)-th-order pattern, namely, a 7th-order pattern, is {code of the 6th-order pattern, (i+4, i+7, B, e, C, IN/OUT)}.

The rightmost path can be obtained in the following manner: The pattern code can organize the nodes into a linear order, and an index is used to mark this order based on a time when the node is discovered, where i<j indicates that a node vi is discovered earlier than a node vj, v0 represents a root node, vn represents a rightmost node, and a path from v0 to vn is referred to as a rightmost path.

According to the technical solution in the example embodiment in FIG. 6, backward extension is performed through forward extension and backward extension. In this way, all the orders of patterns can be efficiently extended, and more potential risk patterns can be obtained through extension.

Further, in an example embodiment, before determining the (K+1)-th-order pattern instance from the to-be-mined full graph, the electronic device 200 determines, based on a target (K+1)-th-order pattern code corresponding to a target (K+1)-th-order pattern obtained through pattern extension, a primal graph corresponding to the target (K+1)-th-order pattern; extends the primal graph based on the target (K+1)-th-order pattern code, to obtain at least one extended instance corresponding to the primal graph; and if a DFS code of each extended instance is greater than or equal to the target (K+1)-th-order pattern code, determines that the target (K+1)-th-order pattern code of the target (K+1)-th-order pattern is the canonical pattern code.

For example, a local instance cache, e.g., Bufferlist, stores the K-th-order pattern instance of the K-th-order pattern. After a plurality of (K+1)-th-order patterns are obtained through extension, it is calculated whether the DFS code of each extended (K+1)-th-order pattern is the canonical pattern code. If the DFS code of the (K+1)-th-order pattern is the canonical pattern code, a corresponding K-th-order pattern instance is read from the local instance cache Bufferlist, to perform instance extension. If the DFS code of the (K+1)-th-order pattern is not the canonical pattern code, it indicates that the (K+1)-th-order pattern is redundant, and the (K+1)-th-order pattern is discarded to avoid repeated calculation. A manner of determining whether the DFS code is the canonical pattern code is as follows: A current DFS code sequence of a pattern is first restored into a primal graph, and then starting from each node in the primal graph, extension is performed in the pattern extension manner described above, to obtain a plurality of extended instances. If a DFS code of the extended instance is less than the current DFS code, the pattern code of the current pattern is not the canonical pattern code.

Based on the technical solution in the above example embodiment, whether the DFS code of the current pattern is the canonical pattern code can be determined through primal graph extension. In this way, the canonical pattern code can be more efficiently determined, to avoid searching an obtained frequent subgraph set for a duplicate subgraph, that is, avoid a problem of generating a redundant candidate subgraph.

In addition, in an example embodiment, the to-be-mined full graph includes a seed node, and the seed node in the to-be-mined full graph can be determined based on a specific scenario. For example, for the risk control scenario, the to-be-mined full graph is an inter-account transfer relation graph, a node in the graph represents an account, an edge in the graph represents a transfer behavior, and the seed node can be a marked risk account node. Starting from the seed node, the electronic device 200 extends the K-th-order pattern and the K-th-order pattern instance of the to-be-mined full graph based on the DFS code. A specific implementation principle and an implementation process of pattern extension and instance extension are the same as those in step S320. Details are not repeated herein.

According to the technical solution in the above example embodiment, the seed node is introduced, and pattern extension and instance extension are performed starting from the seed node. In this way, a scale of graph mining can be reduced to accelerate a mining speed of graph mining, and filtering can be more accurately performed based on external information.

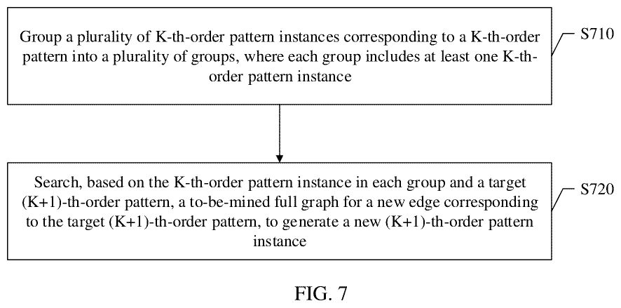

FIG. 7 is a flowchart of extending a pattern instance according to some embodiments.

With reference to FIG. 7, in step S710, a plurality of K-th-order pattern instances corresponding to the K-th-order pattern are grouped into a plurality of groups, where each group includes at least one K-th-order pattern instance.

In an example embodiment, the K-th-order pattern corresponds to a plurality of K-th-order pattern instances. The pattern instance represents a specific node/edge corresponding to a pattern in a graph, and one pattern can correspond to a plurality of pattern instances in the graph. For each K-th-order pattern, the electronic device 200 groups a plurality of K-th-order pattern instances corresponding to the K-th-order pattern into a plurality of groups in a predetermined grouping manner, where each group includes at least one K-th-order pattern instance.

For example, the electronic device 200 groups the plurality of K-th-order pattern instances corresponding to the K-th-order pattern into a plurality of groups in an equal grouping manner, where each group can include a same quantity of pattern instances.

In step S720, the to-be-mined full graph is searched, based on the K-th-order pattern instance in each group and the target (K+1)-th-order pattern, for a new edge corresponding to the target (K+1)-th-order pattern, to generate a new (K+1)-th-order pattern instance.

In an example embodiment, a pattern code corresponding to the target (K+1)-th-order pattern is the canonical pattern code. Instance extension means to find the corresponding (K+1)-th-order instance from the to-be-mined full graph based on the K-th-order pattern instance and the (K+1)-th-order pattern. The electronic device 200 searches, based on the K-th-order pattern instance in each group and the pattern code of the target (K+1)-th-order pattern, the to-be-mined full graph for a new edge corresponding to the target (K+1)-th-order pattern, to generate a new (K+1)-th-order pattern instance.

In some example embodiments, each group corresponds to at least one task, each task corresponds to one thread, and the to-be-mined full graph is searched, in a multithreaded manner based on the K-th-order pattern instance in each group and the target (K+1)-th-order pattern, for a new edge corresponding to the target (K+1)-th-order pattern, to generate a new (K+1)-th-order pattern instance.

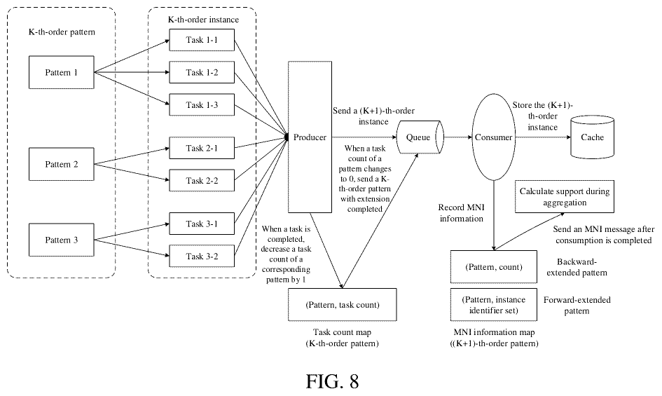

With reference to FIG. 8, the K-th-order pattern includes a pattern 1, a pattern 2, and a pattern 3. For each K-th-order pattern, instances corresponding to the K-th-order pattern are grouped. Each pattern can be divided into several tasks, pattern instance quantities in all the tasks are the same, and each task corresponds to one thread for instance extension. As shown in FIG. 8, the pattern 1 corresponds to a task 1-1, a task 1-2, and a task 1-3, the pattern 2 corresponds to a task 2-1 and a task 2-2, the pattern 3 corresponds to a task 3-1 and a task 3-2, and there are a total of seven corresponding tasks.

A producer is responsible for searching, based on the K-th-order pattern instance and the (K+1)-th-order pattern, for a new edge corresponding to the (K+1)-th-order pattern, to generate a new pattern instance of the (K+1)-th-order pattern, and sending the generated (K+1)-th-order pattern instance to a queue. When extension of a pattern instance in a task is completed, a task count of a corresponding pattern in a task count map is decreased by 1. When a task count of a pattern is changed to 0, a K-th-order pattern with extension completed, for example, a DFS code, is sent to a queue. A consumer obtains information about the pattern with extension completed from the queue, and records a total quantity of completed patterns and support indicator MIN information. The MIN information includes an instance identifier set corresponding to the pattern.

According to the technical solution in the above example embodiment, on one hand, pattern instances are grouped and a multithreaded extension manner is used, to accelerate an instance extension speed. On the other hand, a task and a pattern are counted based on a producer-consumer pattern, so that statistical information of an extended pattern instance can be more accurately recorded.

Further, in an example embodiment, the graph mining method is applied to the distributed system, the distributed system includes a plurality of partitions, and the electronic device 200 sends the sub-support information in the current partition to a target partition in the distributed system based on a pattern extension manner of the (K+1)-th-order pattern in the current partition. The sub-support information includes pattern instance quantities or instance identifiers of pattern instances in all the partitions.

For example, if the pattern extension manner of the (K+1)-th-order pattern in the current partition is backward extension, a pattern instance quantity corresponding to the (K+1)-th-order pattern in the current partition is sent to the target partition in the distributed system; or if the pattern extension manner of the (K+1)-th-order pattern in the current partition is forward extension, an instance identifier set of the pattern instances corresponding to the (K+1)-th-order pattern in the current partition is sent to the target partition in the distributed system. That is, a manner of calculating the support indicator MNI is optimized based on the pattern extension manner, for example, backward extension and forward extension. The following provides detailed descriptions.

With reference to FIG. 8, the consumer obtains message data from the queue, and the message data includes the following two types of messages: Message 1: If the message is a (K+1)-th-order pattern instance, the message is stored in a cache storage, and continues to be extended for a next round of iteration. Message 2: If the message is information about the pattern with extension completed, for example, a pattern key, a count of finished patterns is increased by 1 until the total quantity of patterns is reached, and the consumer stops consumption. The pattern key is used to uniquely identify a pattern. Then, MNI information of each (K+1)-th-order pattern is sent, and the MIN information is used to calculate the support in the aggregation phase. For different extension manners, different messages are sent. Refer to FIG. 8 and the following: 1. For a backward-extended pattern: Because no new node is introduced through backward extension, an MNI value does not change, and the sub-support information is a quantity of pattern instances obtained through extension for the (K+1)-th-order pattern. Therefore, an instance count, that is, the support information, is sent to an aggregation module for summarization and aggregation. In this way, a size of a sent message can be effectively reduced. 2. For a forward-extended pattern: Because a new node is introduced through forward extension, an MNI value may change. Therefore, during extension, the instance identifier set, that is, the sub-support information vertexIdSet, of the current pattern is recorded, and is sent as a message to an aggregation module for summarization and aggregation. The aggregation module summarizes and aggregates the received sub-support information, that is, MNI information, to calculate support of the (K+1)-th-order pattern.

According to the technical solution in the above example embodiment, on one hand, the sub-support information of the (K+1)-th-order pattern in the current partition is sent based on the pattern extension manner, and only the instance quantity is sent for backward extension, so that the sent message that includes the sub-support information can be compressed. On the other hand, the support is calculated by using different information for different pattern extension manners, so that support, that is, MNI, calculation can be optimized.

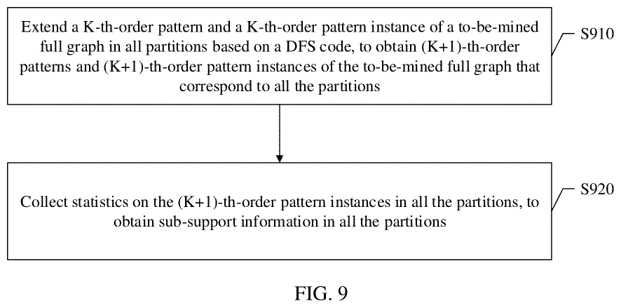

FIG. 9 is a flowchart of a graph mining method applied to a distributed system according to some embodiments.

With reference to FIG. 9, in step S910, a K-th-order pattern and a K-th-order pattern instance of a to-be-mined full graph are extended in all partitions based on a DFS code, to obtain (K+1)-th-order patterns and (K+1)-th-order pattern instances of the to-be-mined full graph that correspond to all the partitions.

In an example embodiment, the graph mining method is applied to the distributed system, the distributed system includes a plurality of partitions, and electronic devices 200 in all the partitions extend the K-th-order pattern and the K-th-order pattern instance of the to-be-mined full graph in parallel in all the partitions based on the DFS code, to obtain the (K+1)-th-order patterns and the (K+1)-th-order pattern instances of the to-be-mined full graph that correspond to all the partitions. A specific implementation principle and an implementation process of pattern extension and instance extension are the same as those in step S320. Details are not repeated herein.

In step S920, statistics on the (K+1)-th-order pattern instances in all the partitions are collected, to obtain sub-support information in all the partitions.

In an example embodiment, the sub-support information includes pattern instance quantities or instance identifiers of pattern instances in all the partitions. The electronic devices 200 in all the partitions collect statistics on the (K+1)-th-order pattern instances in all the partitions, to obtain the sub-support information in all the partitions. For example, for the (K+1)-th-order pattern in a current partition, if the (K+1)-th-order pattern is a backward-extended pattern, statistics on a quantity of pattern instances in the current partition are collected, to obtain a pattern instance quantity; or if the (K+1)-th-order pattern is a forward-extended pattern, statistics on an identifier of the pattern instance in the current partition are collected, to obtain an instance identifier set.

According to the technical solution in the example embodiment in FIG. 9, the K-th-order pattern and the K-th-order pattern instance of the to-be-mined full graph are extended in parallel in all the partitions, to improve efficiency of pattern extension and instance extension, so as to improve graph mining efficiency.

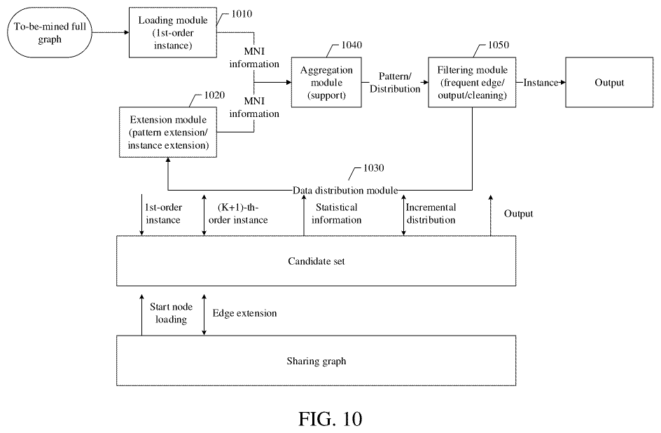

FIG. 10 is a schematic diagram of a graph mining method according to some embodiments.

With reference to FIG. 10, the graph mining method may be implemented by using a distributed graph computing engine as a software architecture. The distributed graph computing engine may be based on a vertex center method. Through iteration, in each round, each node sends a message to another node in a distributed system, and performs processing and analysis when receiving a message in a next round. Each round of iteration is divided into the following three main phases: (1) Extension phase: A (K+1)-th-order pattern and a (K+1)-th-order pattern instance are obtained through extension based on a K-th-order pattern (the pattern has K edges) and a K-th-order pattern instance, and statistical information such as sub-support information of a same pattern is sent to a corresponding partition. The sub-support information includes pattern instance quantities or instance identifiers of pattern instances in all partitions. (2) Aggregation phase: Support of all (K+1)-th-order patterns is summarized and calculated, and is sent to all the partitions in the distributed system through broadcasting. (3) Filtering phase: A target-order pattern that meets the support is obtained through filtering, is sent to all the partitions in the distributed system through broadcasting, and continues to be extended for a next round of iteration.

Still with reference to FIG. 10, the software architecture of the graph mining method includes a loading module 1010, an extension module 1020, a data distribution module 1030, an aggregation module 1040, and a filtering module 1050. The loading module 1010 is configured to load all orders of pattern instances corresponding to all orders of patterns from a to-be-mined full graph, for example, load a 1st-order pattern instance corresponding to a 1st-order pattern. The extension module 1020 is configured to: obtain a (K+1)-th-order pattern and a (K+1)-th-order pattern instance based on a K-th-order pattern and a K-th-order pattern instance, and send MNI information of a same pattern to the aggregation module 1040. The data distribution module 1030 can also be referred to as a data distribution shuffle module, and is configured to perform data distribution across nodes and processes within a cluster in a distributed computing scenario. For example, the data distribution module 1030 stores the (K+1)-th-order pattern instance obtained by the extension module 1020 through extension in a candidate set, and obtains the (K+1)-th-order pattern instance from the candidate set in a next round of iteration. The data distribution module 1030 further distributes statistical information such as pattern instance statistical information of a same pattern to a corresponding partition for aggregation. The data distribution module 1030 can further perform incremental distribution on incremental data in the candidate set, to avoid repeated data sending.

Further, the aggregation module 1040 is configured to: summarize and calculate support of each (K+1)-th-order pattern based on MNI information in all the partitions, and send the calculated support of each (K+1)-th-order pattern to the corresponding partitions in the distributed system through broadcasting. The filtering module 1050 is configured to: obtain a target-order pattern, that is, a frequent subgraph that frequently occurs in the to-be-mined full graph, that meets the support through filtering, and broadcast the target-order pattern to all the partitions in the distributed system.

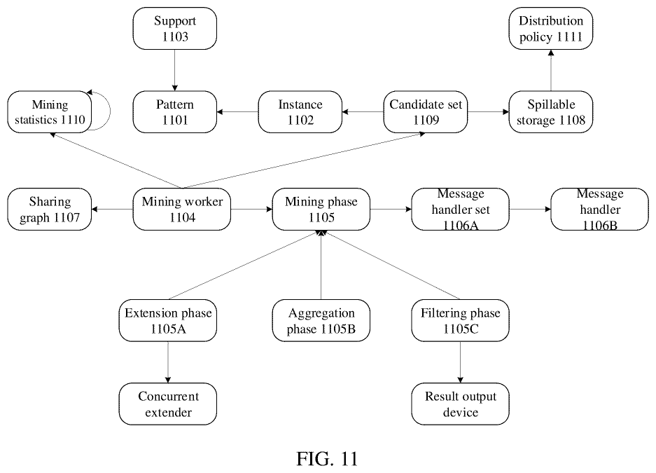

FIG. 11 is a domain model diagram of various modules for implementing a graph mining method according to some embodiments.

With reference to FIG. 11, the domain model diagram mainly includes the following components: (1) A pattern 1101 is used to represent a specific subgraph structure of a to-be-mined full graph. (2) An instance 1102 (Embedding) is used to represent a specific subgraph corresponding to the pattern in the to-be-mined full graph, and includes a node and an edge in the subgraph corresponding to the pattern. (3) Support 1103 is used to represent occurrence frequency of a pattern in a graph, for example, a quantity of occurrences. (4) A mining unit, also referred to as a mining worker 1104, is configured to execute a specific graph mining task based on a sharing graph, that is, the to-be-mined full graph, in a mining framework. (5) Mining phase 1105: The mining phase includes an extension phase 1105A, an aggregation phase 1105B, and a filtering phase 1105C. In the extension phase 1105A, concurrent extension is performed by using a concurrent extender. (6) Message handler set 1106A and message handler 1106B Message/MsgHandler: Different types of messages are received and sent in different phases and processed by corresponding message handlers. (7) A sharing graph 1107 is a base graph that stores a node and an edge and that corresponds to the to-be-mined full graph. (8) A spillable storage 1108 is an actual storage set, and is used to store a pattern instance Embedding obtained through extension. (9) A candidate set 1109 is a logical storage set, and is used to operate the actual storage set such as a mined (K+1)-th-order pattern instance. (10) Mining statistics 1110 (worker statistics) are used to collect statistics on pattern instances mined by the mining worker. (11) A distribution policy 1111 is used to perform data distribution across nodes and processes within a cluster in a distributed computing scenario.

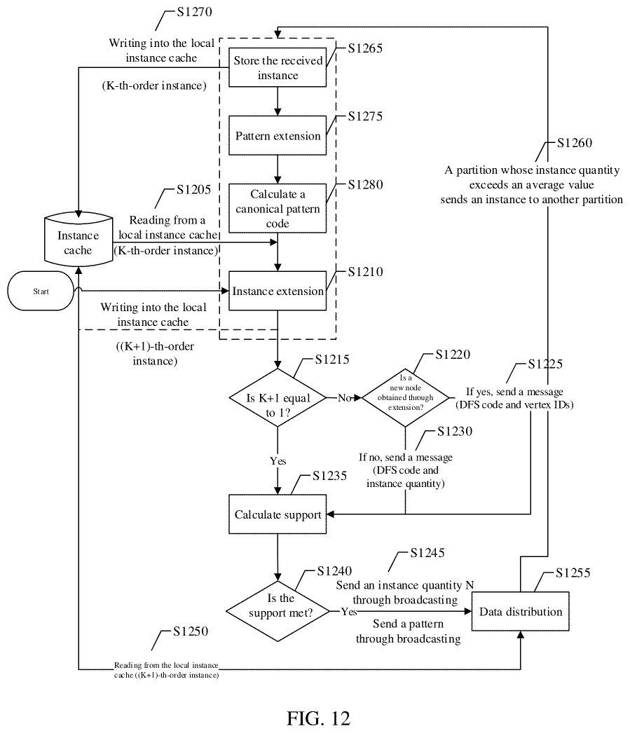

FIG. 12 is a flowchart of a graph mining method according to some embodiments.

With reference to FIG. 12, in step S1205, a K-th-order pattern instance of a to-be-mined full graph is obtained from an instance cache.

In an example embodiment, the electronic device 200 (FIG. 2) obtains the K-th-order pattern instance corresponding to a K-th-order pattern of the to-be-mined full graph from the instance cache Bufferlist. When K is 0,it indicates that the pattern is a node, that is, has 0 edges; when K is 1, it indicates that the pattern has one edge; when K is 2, it indicates that the pattern has two edges; and the like. In an initial phase, a 0th-order instance, that is, an initial node, corresponding to a 0th-order pattern of the to-be-mined full graph is obtained, and the initial node can be a root node or a seed node.
In step S1210, the K-th-order instance is extended.

In an example embodiment, the electronic device 200 determines a (K+1)-th-order pattern instance from the to-be-mined full graph based on a (K+1)-th-order pattern and the K-th-order pattern instance, and writes the extended (K+1)-th-order pattern instance into the local instance cache Bufferlist. An implementation process and an implementation effect of instance extension are similar to those in the above described embodiment. Details are not repeated herein.
In step S1215, it is determined whether K+1 is equal to 1.

In an example embodiment, the electronic device 200 determines whether K+1 is equal to 1. If K+1 is equal to 1, step S1235 is performed. If K+1 is not equal to 1, step S1220 is performed.
In step S1220, it is determined whether a new node is obtained through extension.

In an example embodiment, the electronic device 200 determines whether a new node is obtained through extension of the (K+1)-th-order pattern. If a new node is obtained through extension, step S1225 is performed. If no new node is obtained through extension, step S1230 is performed.
In step S1225, an instance identifier set corresponding to the (K+1)-th-order pattern is sent.

In an example embodiment, when a new node is obtained through extension, the electronic device 200 sends the instance identifier set corresponding to the (K+1)-th-order pattern, that is, vertexIdSet.
In step S1230, an instance quantity corresponding to the (K+1)-th-order pattern is sent.

In an example embodiment, when no new node is obtained through extension, the electronic device 200 sends the instance quantity corresponding to the (K+1)-th-order pattern.
In step S1235, support corresponding to the (K+1)-th-order pattern is calculated.

In an example embodiment, for a distributed system, each partition may have a corresponding pattern instance for a same pattern, and global support cannot be directly calculated. Therefore, in an aggregation phase, electronic devices 200 in all partitions send MNI information of the same pattern to a same partition, namely, a target partition. An electronic device 200 in the target partition summarizes and aggregates the received MNI information of the (K+1)-th-order pattern, to calculate a support indicator, for example, an MNI value, corresponding to the (K+1)-th-order pattern.
In step 1240, it is determined whether the support is met.

In an example embodiment, support of each (K+1)-th-order pattern is compared with a predetermined support threshold. If the support indicator of the (K+1)-th-order pattern is greater than the predetermined support threshold, the (K+1)-th-order pattern is determined as a target-order pattern that meets the support indicator. If the support indicator of the (K+1)-th-order pattern is less than or equal to the predetermined support threshold, it is determined that the support indicator is not met.
In step S1245, the target pattern that meets the support and an instance quantity corresponding to the target pattern are sent through broadcasting.
In step S1250, the (K+1)-th-order instance is read from the local instance cache.
In step S1255, data distribution is performed.

In an example embodiment, data distribution is performed across nodes and processes within a cluster in a distributed computing scenario.
In step S1260, a partition whose instance quantity exceeds an average value sends an instance to another partition.

In an example embodiment, the electronic device 200 determines the target partition whose instance quantity of the target pattern exceeds the average value, and sends a pattern instance of the target pattern obtained through extension in the target partition to another partition. The target pattern is the (K+1)-th-order pattern that meets the support indicator. The pattern instance of the target partition whose instance quantity of the target pattern exceeds the average value is sent to the another partition, to improve graph mining efficiency in the another partition.
In step S1265, the received instance is stored.

In an example embodiment, the electronic devices 200 in all the partitions store the received pattern instance of the target pattern.
In step S1270, the received instance is written into the local instance cache Bufferlist.

In an example embodiment, the electronic devices 200 in all the partitions write the received instance into the local instance cache Bufferlist.
In step S1275, pattern extension is performed.

In an example embodiment, the electronic device 200 extends the K-th-order pattern through pattern extension based on a pattern code corresponding to the K-th-order pattern of the to-be-mined full graph, to obtain a plurality of (K+1)-th-order patterns of the to-be-mined full graph. An implementation process and an implementation effect of pattern extension are similar to those in the above described embodiment. Details are not repeated herein.
In step S1280, a canonical pattern code is calculated.

In an example embodiment, the canonical pattern code represents a code sequence with a smallest code sequence order in the DFS code of the pattern graph. A graph may have a plurality of pattern codes, and the electronic device 200 selects a canonical pattern code as a unique code of the graph. An implementation process and an implementation effect of calculating a canonical pattern code of a pattern are similar to those in the above described embodiment. Details are not repeated herein.

Further, if a pattern code corresponding to a target (K+1)-th-order pattern in the plurality of (K+1)-th-order patterns is a canonical pattern code, the electronic device 200 determines the (K+1)-th-order pattern instance from the to-be-mined full graph based on the target (K+1)-th-order pattern and the K-th-order pattern instance; or if a pattern code corresponding to a target (K+1)-th-order pattern is not a canonical pattern code, the electronic device 200 discards the DFS code corresponding to the target (K+1)-th-order pattern, to avoid repeated calculation.

According to the technical solution in the example embodiment in FIG. 12, on one hand, a K-th-order pattern and a K-th-order pattern instance of a to-be-mined full graph are extended based on a DFS code, to obtain a (K+1)-th-order pattern and a (K+1)-th-order pattern instance of the to-be-mined full graph. In this way, the pattern and the instance of the graph can be automatically and efficiently extended, thereby improving graph mining efficiency. On the other hand, graph isomorphism testing and duplicate graph detection are combined through the canonical pattern code, to avoid searching an obtained frequent subgraph set for a duplicate subgraph, that is, avoid a problem of generating a redundant candidate subgraph. In addition, support corresponding to all orders of patterns of the to-be-mined full graph is determined based on quantities of pattern instances corresponding to all the orders of patterns; and a subgraph corresponding to a target-order pattern whose support is greater than a predetermined support threshold is determined as a frequent subgraph of the to-be-mined full graph. In this way, various potential risk patterns can be automatically and efficiently mined on a relation graph in an unsupervised graph mining manner, so that a corresponding risk pattern can be sensed in an earlier phase of a lifecycle of a large-scale fraud behavior, to cope with a rapidly changing fraud situation in a timely manner and automatically perform fraud risk control.

This specification provides a graph mining method and an electronic device, to automatically and efficiently mine a potential risk pattern on a relation graph.

According to a first aspect, this specification provides a graph mining method, including: obtaining a depth first search (DFS) code corresponding to a to-be-mined full graph in a predetermined scenario; extending a K-th-order pattern and a K-th-order pattern instance of the to-be-mined full graph based on the DFS code, to obtain a (K+1)-th-order pattern and a (K+1)-th-order pattern instance of the to-be-mined full graph, where K is an integer greater than or equal to 0; determining, based on quantities of pattern instances corresponding to all orders of patterns of the to-be-mined full graph, support corresponding to all the orders of patterns; and determining a frequent subgraph of the to-be-mined full graph based on the support corresponding to all the orders of patterns.

In some example embodiments, the DFS code is a code in a form of a sextuple, and the sextuple includes a start node identifier of an edge, an end node identifier of the edge, a start node label of the edge, an edge label, an end node label of the edge, and a direction of the edge.

In some example embodiments, the extending a K-th-order pattern and a K-th-order pattern instance of the to-be-mined full graph based on the DFS code, to obtain a (K+1)-th-order pattern and a (K+1)-th-order pattern instance of the to-be-mined full graph includes: extending the K-th-order pattern through pattern extension based on a K-th-order pattern code corresponding to the K-th-order pattern of the to-be-mined full graph, to obtain (K+1)-th-order pattern codes of a plurality of (K+1)-th-order patterns of the to-be-mined full graph, where the (K+1)-th-order pattern corresponds to at least one (K+1)-th-order pattern code; and if a target (K+1)-th-order pattern code corresponding to the plurality of (K+1)-th-order patterns is a canonical pattern code, determining the (K+1)-th-order pattern instance from the to-be-mined full graph based on the target (K+1)-th-order pattern code and the K-th-order pattern instance, where the pattern code is at least one code generated based on the DFS code corresponding to a subgraph of the pattern in the to-be-mined full graph, and the canonical pattern code is a pattern code used to uniquely identify the pattern.

In some example embodiments, the extending the K-th-order pattern through pattern extension based on a K-th-order pattern code corresponding to the K-th-order pattern of the to-be-mined full graph includes: extending the K-th-order pattern through forward extension based on the K-th-order pattern code corresponding to the K-th-order pattern of the to-be-mined full graph; and extending the K-th-order pattern through backward extension based on the K-th-order pattern code corresponding to the K-th-order pattern of the to-be-mined full graph.

In some example embodiments, the K-th-order pattern corresponds to a plurality of K-th-order pattern instances, and the determining the (K+1)-th-order pattern instance from the to-be-mined full graph based on the target (K+1)-th-order pattern code and the K-th-order pattern instance includes: grouping the plurality of K-th-order pattern instances corresponding to the K-th-order pattern into a plurality of groups, where each group includes at least one K-th-order pattern instance; and searching, based on the K-th-order pattern instance in each group and the target (K+1)-th-order pattern code, the to-be-mined full graph for a new edge corresponding to the target (K+1)-th-order pattern code, to generate a new (K+1)-th-order pattern instance.

In some example embodiments, each group corresponds to at least one task, each task corresponds to one thread, and the searching, based on the K-th-order pattern instance in each group and the target (K+1)-th-order pattern code, the to-be-mined full graph for a new edge corresponding to the target (K+1)-th-order pattern code, to generate a new (K+1)-th-order pattern instance includes: searching, in a multithreaded manner based on the K-th-order pattern instance in each group and the target (K+1)-th-order pattern code, the to-be-mined full graph for a new edge corresponding to the target (K+1)-th-order pattern code, to generate a new (K+1)-th-order pattern instance.

In some example embodiments, before the determining the (K+1)-th-order pattern instance from the to-be-mined full graph, the method further includes: determining, based on a target (K+1)-th-order pattern code corresponding to a target (K+1)-th-order pattern obtained through pattern extension, a primal graph corresponding to the target (K+1)-th-order pattern code; extending the primal graph based on the target (K+1)-th-order pattern code, to obtain at least one (K+1)-th-order extended instance corresponding to the primal graph; and if a DFS code of each (K+1)-th-order extended instance is greater than or equal to a DFS code corresponding to the target (K+1)-th-order pattern code, determining that the target (K+1)-th-order pattern code of the target (K+1)-th-order pattern is the canonical pattern code.

In some example embodiments, the graph mining method is applied to a distributed system, the distributed system includes a plurality of partitions, and the extending a K-th-order pattern and a K-th-order pattern instance of the to-be-mined full graph based on the DFS code, to obtain a (K+1)-th-order pattern and a (K+1)-th-order pattern instance of the to-be-mined full graph includes: extending the K-th-order pattern and the K-th-order pattern instance of the to-be-mined full graph in all the partitions based on the DFS code, to obtain (K+1)-th-order patterns and (K+1)-th-order pattern instances of the to-be-mined full graph that correspond to all the partitions; and collecting statistics on the (K+1)-th-order pattern instances in all the partitions, to obtain sub-support information in all the partitions.

In some example embodiments, the method further includes: sending the sub-support information in a current partition to a target partition in the distributed system based on a pattern extension manner of the (K+1)-th-order pattern in the current partition.

In some example embodiments, the sending the sub-support information in a current partition to a target partition in the distributed system based on a pattern extension manner of the (K+1)-th-order pattern in the current partition includes: if the pattern extension manner of the (K+1)-th-order pattern in the current partition is backward extension, sending a pattern instance quantity corresponding to the (K+1)-th-order pattern in the current partition to the target partition in the distributed system; or if the pattern extension manner of the (K+1)-th-order pattern in the current partition is forward extension, sending an instance identifier set of the pattern instances corresponding to the (K+1)-th-order pattern in the current partition to the target partition in the distributed system.

In some example embodiments, the determining, based on quantities of pattern instances corresponding to all orders of patterns of the to-be-mined full graph, support corresponding to all the orders of patterns includes: aggregating the sub-support information of the (K+1)-th-order pattern in all the partitions, to obtain a support indicator of the (K+1)-th-order pattern, where the support indicator meets anti-monotonicity.

In some example embodiments, the determining a frequent subgraph of the to-be-mined full graph based on the support corresponding to all the orders of patterns includes: if the support indicator of the (K+1)-th-order pattern is greater than a predetermined support threshold, determining the (K+1)-th-order pattern as a target-order pattern that meets the support indicator; and determining a subgraph corresponding to the target-order pattern as the frequent subgraph of the to-be-mined full graph.

In some example embodiments, the method further includes: sending the target-order pattern to all the partitions in the distributed system through broadcasting.

In some example embodiments, the preset scenario is a risk control scenario, and the support is a risk degree.

In some example embodiments, the to-be-mined full graph includes a seed node, and the extending a K-th-order pattern and a K-th-order pattern instance of the to-be-mined full graph based on the DFS code includes: starting from the seed node, extending the K-th-order pattern and the K-th-order pattern instance of the to-be-mined full graph based on the DFS code.

According to a second aspect, this specification further provides an electronic device, including: a processor; and a memory storing instructions executable by the processor. The processor is configured to perform the graph mining methods described above.

According to the graph mining method and the device provided in the embodiments of this specification, on one hand, a K-th-order pattern and a K-th-order pattern instance of a to-be-mined full graph are extended based on a DFS code, to obtain a (K+1)-th-order pattern and a (K+1)-th-order pattern instance of the to-be-mined full graph. In this way, the pattern and the instance of the graph can be automatically and efficiently extended, thereby improving graph mining efficiency. On the other hand, support corresponding to all orders of patterns of the to-be-mined full graph is determined based on quantities of pattern instances corresponding to all the orders of patterns; and a subgraph corresponding to a target-order pattern whose support is greater than a predetermined support threshold is determined as a frequent subgraph of the to-be-mined full graph. In this way, various potential risk patterns can be automatically and efficiently mined on a relation graph in an unsupervised graph mining manner, so that a corresponding risk pattern can be sensed in an earlier phase of a lifecycle of a large-scale fraud behavior, to cope with a rapidly changing fraud situation in a timely manner and automatically perform fraud risk control.

According to another aspect of this specification, a non-transitory computer-readable storage medium is provided, and stores instructions for performing graph mining processing. When the instructions are executed by a processor, the instructions cause the processor to perform the graph mining method described in this specification. The non-transitory storage medium can be a portable compact disc read-only memory (CD-ROM) that includes program code, and can be run on the electronic device 200 (FIG. 2). The storage medium can also be any tangible medium that includes or stores a program, and the program can be used by or in combination with an instruction execution system. More specific examples of the storage medium include a portable disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any proper combination thereof. The program code included in the storage medium can be transmitted by using any proper medium, including but not limited to a wireless medium, a wired medium, an optical cable, an RF medium, or any proper combination thereof. Program code for performing the operations in this specification can be written in any combination of one or more program design languages. The program design language includes an object-oriented program design language, for example, Java or C++, and further includes a conventional procedural program design language, for example, a “C” language, or a similar program design language. The program code can be completely executed on the electronic device 200, partially executed on the electronic device 200, executed as an independent software package, partially executed on the electronic device 200 and partially executed on a remote computing device, or completely executed on a remote computing device.

Example embodiments of this specification are described above. Other embodiments fall within the scope of the appended claims. In some situations, the actions or steps described in the claims can be performed in an order different from the order in the embodiments and the desired results can still be achieved. In addition, the process depicted in the accompanying drawings does not necessarily need a particular order or consecutive order to achieve the desired results. In some implementations, multitasking and parallel processing are possible or may be advantageous.

Although it is not explicitly stated herein, a person skilled in the art can understand that this specification includes various proper changes, improvements, and modifications to the embodiments. These changes, improvements, and modifications fall within the spirit and scope of the example embodiments of this specification.

In addition, some terms in this specification are used to describe the embodiments of this specification. For example, “an embodiment”, “embodiments”, and/or “some embodiments” mean/means that specific features, structures, or characteristics described with reference to the embodiment can be included in at least one embodiment of this specification. Therefore, it can be understood that two or more references to “embodiments”, “an embodiment”, or “alternative embodiments” in various parts of this specification do not necessarily refer to a same embodiment. In addition, specific features, structures, or characteristics can be properly combined in one or more embodiments of this specification.

It should be understood that in the above descriptions of example embodiments of this specification, various features may be combined in a single embodiment, figure, or description thereof in this specification. However, this does not mean that the combination of these features is necessary.

It should also be understood that the embodiments disclosed in this specification describe the principles of the embodiments of this specification. Other modified embodiments also fall within the scope of this specification. The embodiments disclosed in this specification are merely examples and not limitations. A person skilled in the art can use an alternative configuration according to the embodiments of this specification to implement the application in this specification. Therefore, the embodiments of this specification are not limited to the described embodiments.

1. A graph mining method, comprising:
obtaining a depth first search (DFS) code corresponding to a to-be-mined full graph in a predetermined scenario;
extending a K-th-order pattern and a K-th-order pattern instance of the to-be-mined full graph based on the DFS code, to obtain a (K+1)-th-order pattern and a (K+1)-th-order pattern instance of the to-be-mined full graph, wherein K is an integer greater than or equal to 0;
determining, based on quantities of pattern instances corresponding to all orders of patterns of the to-be-mined full graph, support corresponding to all the orders of patterns; and
determining a frequent subgraph of the to-be-mined full graph based on the support corresponding to all the orders of patterns.

2. The method according to claim 1, wherein the DFS code is in a form of a sextuple, and the sextuple comprises a start node identifier of an edge, an end node identifier of the edge, a start node label of the edge, an edge label of the edge, an end node label of the edge, and a direction of the edge.

3. The method according to claim 1, wherein the extending the K-th-order pattern and the K-th-order pattern instance of the to-be-mined full graph based on the DFS code, to obtain the (K+1)-th-order pattern and the (K+1)-th-order pattern instance of the to-be-mined full graph comprises:
extending the K-th-order pattern through pattern extension based on a K-th-order pattern code corresponding to the K-th-order pattern of the to-be-mined full graph, to obtain (K+1)-th-order pattern codes of a plurality of (K+1)-th-order patterns of the to-be-mined full graph, wherein the (K+1)-th-order pattern corresponds to at least one (K+1)-th-order pattern code; and
if a target (K+1)-th-order pattern code corresponding to the (K+1)-th-order pattern is a canonical pattern code, determining the (K+1)-th-order pattern instance from the to-be-mined full graph based on the target (K+1)-th-order pattern code and the K-th-order pattern instance,
wherein the pattern code is at least one code generated based on a DFS code corresponding to a subgraph of the pattern in the to-be-mined full graph, and the canonical pattern code is a pattern code used to uniquely identify the pattern.

4. The method according to claim 3, wherein the extending the K-th-order pattern through pattern extension based on the K-th-order pattern code corresponding to the K-th-order pattern of the to-be-mined full graph comprises:
extending the K-th-order pattern through forward extension based on the K-th-order pattern code corresponding to the K-th-order pattern of the to-be-mined full graph; and
extending the K-th-order pattern through backward extension based on the K-th-order pattern code corresponding to the K-th-order pattern of the to-be-mined full graph.

5. The method according to claim 3, wherein the K-th-order pattern corresponds to a plurality of K-th-order pattern instances, and the determining the (K+1)-th-order pattern instance from the to-be-mined full graph based on the target (K+1)-th-order pattern code and the K-th-order pattern instance comprises:
grouping the plurality of K-th-order pattern instances corresponding to the K-th-order pattern into a plurality of groups, wherein each group comprises at least one K-th-order pattern instance; and
searching, based on the K-th-order pattern instance in each group and the target (K+1)-th-order pattern code, the to-be-mined full graph for a new edge corresponding to the target (K+1)-th-order pattern code, to generate a new (K+1)-th-order pattern instance.

6. The method according to claim 5, wherein each group corresponds to at least one task, each task corresponds to one thread, and the searching, based on the K-th-order pattern instance in each group and the target (K+1)-th-order pattern code, the to-be-mined full graph for a new edge corresponding to the target (K+1)-th-order pattern code, to generate a new (K+1)-th-order pattern instance comprises:
searching, in a multithreaded manner based on the K-th-order pattern instance in each group and the target (K+1)-th-order pattern code, the to-be-mined full graph for a new edge corresponding to the target (K+1)-th-order pattern code, to generate a new (K+1)-th-order pattern instance.

7. The method according to claim 3, wherein before the determining the (K+1)-th-order pattern instance from the to-be-mined full graph, the method further comprises:
determining, based on a target (K+1)-th-order pattern code corresponding to a target (K+1)-th-order pattern obtained through pattern extension, a primal graph corresponding to the target (K+1)-th-order pattern code;
extending the primal graph based on the target (K+1)-th-order pattern code, to obtain at least one (K+1)-th-order extended instance corresponding to the primal graph; and
if a DFS code of each (K+1)-th-order extended instance is greater than or equal to a DFS code corresponding to the target (K+1)-th-order pattern code, determining that the target (K+1)-th-order pattern code of the target (K+1)-th-order pattern is the canonical pattern code.

8. The method according to claim 1, wherein the graph mining method is applied to a distributed system, the distributed system comprises a plurality of partitions, and the extending the K-th-order pattern and the K-th-order pattern instance of the to-be-mined full graph based on the DFS code, to obtain the (K+1)-th-order pattern and the (K+1)-th-order pattern instance of the to-be-mined full graph comprises:
extending the K-th-order pattern and the K-th-order pattern instance of the to-be-mined full graph in all the partitions based on the DFS code, to obtain (K+1)-th-order patterns and (K+1)-th-order pattern instances of the to-be-mined full graph that correspond to all the partitions; and
collecting statistics on the (K+1)-th-order pattern instances in all the partitions, to obtain sub-support information in all the partitions.

9. The method according to claim 8, further comprising:
sending the sub-support information in a current partition to a target partition in the distributed system based on a pattern extension manner of the (K+1)-th-order pattern in the current partition.

10. The method according to claim 9, wherein the sending the sub-support information in the current partition to the target partition in the distributed system based on the pattern extension manner of the (K+1)-th-order pattern in the current partition comprises:
if the pattern extension manner of the (K+1)-th-order pattern in the current partition is backward extension, sending a pattern instance quantity corresponding to the (K+1)-th-order pattern in the current partition to the target partition in the distributed system; or
if the pattern extension manner of the (K+1)-th-order pattern in the current partition is forward extension, sending an instance identifier set of the pattern instances corresponding to the (K+1)-th-order pattern in the current partition to the target partition in the distributed system.

11. The method according to claim 8, wherein the determining, based on the quantities of pattern instances corresponding to all orders of patterns of the to-be-mined full graph, support corresponding to all the orders of patterns comprises:
aggregating the sub-support information of the (K+1)-th-order pattern in all the partitions, to obtain a support indicator of the (K+1)-th-order pattern, wherein the support indicator meets anti-monotonicity.

12. The method according to claim 11, wherein the determining the frequent subgraph of the to-be-mined full graph based on the support corresponding to all the orders of patterns comprises:
if the support indicator of the (K+1)-th-order pattern is greater than a predetermined support threshold, determining the (K+1)-th-order pattern as a target-order pattern that meets the support indicator; and
determining a subgraph corresponding to the target-order pattern as the frequent subgraph of the to-be-mined full graph.

13. The method according to claim 12, the method further comprising:
sending the target-order pattern to all the partitions in the distributed system through broadcasting.

14. The method according to claim 1, wherein the predetermined scenario is a risk control scenario, and the support is a risk degree.

15. The method according to claim 1, wherein the to-be-mined full graph comprises a seed node, and the extending the K-th-order pattern and the K-th-order pattern instance of the to-be-mined full graph based on the DFS code comprises:
starting from the seed node, extending the K-th-order pattern and the K-th-order pattern instance of the to-be-mined full graph based on the DFS code.

16. An electronic device, comprising:
a processor; and
a memory storing instructions executable by the processor;
wherein the processor is configured to:
obtain a depth first search (DFS) code corresponding to a to-be-mined full graph in a predetermined scenario;
extend a K-th-order pattern and a K-th-order pattern instance of the to-be-mined full graph based on the DFS code, to obtain a (K+1)-th-order pattern and a (K+1)-th-order pattern instance of the to-be-mined full graph, wherein K is an integer greater than or equal to 0;
determine, based on quantities of pattern instances corresponding to all orders of patterns of the to-be-mined full graph, support corresponding to all the orders of patterns; and
determine a frequent subgraph of the to-be-mined full graph based on the support corresponding to all the orders of patterns.

17. A non-transitory computer-readable storage medium storing instructions that, when executed by a processor, cause the processor to perform a graph mining method, the method comprising:
obtaining a depth first search (DFS) code corresponding to a to-be-mined full graph in a predetermined scenario;
extending a K-th-order pattern and a K-th-order pattern instance of the to-be-mined full graph based on the DFS code, to obtain a (K+1)-th-order pattern and a (K+1)-th-order pattern instance of the to-be-mined full graph, wherein K is an integer greater than or equal to 0;
determining, based on quantities of pattern instances corresponding to all orders of patterns of the to-be-mined full graph, support corresponding to all the orders of patterns; and
determining a frequent subgraph of the to-be-mined full graph based on the support corresponding to all the orders of patterns.
